(19) United States
(12) Patent Application Publication
(10) Pub. No.: US 2008/0303777 A1
(43) Pub. Date: Dec. 11, 2008

(54) OPTICAL ADJUSTING MEMBER, AND ILLUMINATION DEVICE AND LIQUID CRYSTAL DISPLAY DEVICE INCLUDING THE SAME

(76) Inventors: Kazuko INOUE, Osaka (JP); Katsusuke Shimazaki, Osaka (JP); Eiji Koyama, Osaka (JP)

Correspondence Address: BIRCH STEWART KOLASCH & BIRCH, PO BOX 747, FALLS CHURCH, VA, 22040-0747, US

(21) Appl. No.: 12/134,937

(22) Filed: Jun. 6, 2008

(30) Foreign Application Priority Data
Jun. 8, 2007 (JP) 2007-152611
Sep. 26, 2007 (JP) 2007-250226

(51) Int. Cl. G09G 3/36

(52) U.S. Cl. 345/102

(57) ABSTRACT

An optical adjusting member according to the invention includes a base member, a plurality of lenses, and a light diffusion layer. The base member has optical transparency. The plurality of lenses are formed on the base member. The light diffusion layer is formed on the plurality of lenses, and at least top edge parts of the lenses are buried in the light diffusion layer. In the optical adjusting member according to the invention, at least the top edge parts of the plurality of lenses are buried in the light diffusion layer and therefore the lenses are less susceptible to damages. The optical adjusting member according to the invention has a light collecting function by the lenses and a diffusion function by the light diffusion layer.

### BACKGROUND OF THE INVENTION

1. Field of the Invention

The present invention relates to an optical adjusting member, an illumination device and a liquid crystal display device including the same, and a method of manufacturing an optical adjusting member.

2. Description of the Background Art

Conventional illumination devices such as a backlight unit for a liquid crystal display each include a mechanism for adjusting the diffusion and brightness of light from a light source. Most illumination devices include an optical adjusting member used to control the directivity of light. The optical adjusting member has optical transparency and is capable of collimating incident light in a predetermined direction or diffusing incident light.

A prism sheet is a typical example of the optical adjusting member capable of collimating incident light in a predetermined direction, i.e., capable of controlling its optical directivity (see for example JP 09-133919 A). In general, the prism sheet is produced by arranging a plurality of optical members that extend in a predetermined direction and having a triangular section orthogonal to the lengthwise direction (hereinafter referred to as “prisms”) or a plurality of optical members having an arch shaped section such as a semi-circular section and a semi-elliptical section (hereinafter referred to as “cylindrical lenses”) on a sheet type base member. The prism refers to a shape in which the lateral faces on both sides of a lateral edge are substantially flat. An example of the prism sheet is shown in FIG. 20. As shown in FIG. 20, the prism sheet 505 includes a sheet type base member 505a and a plurality of prisms 505b provided side by side on the sheet type base member 50a. The prism sheet controls the traveling direction of light by a prism effect or a lens effect by the plurality of prisms.

FIG. 21 shows a general structure of a liquid crystal display device including the prism sheet described above. The liquid crystal display device 500 is a side light type (edge light type) device and includes a liquid crystal display panel 507 and a backlight unit 508. The backlight unit 508 includes a light source 501, a light guide plate 502 that changes light radiated from the light source 501 into a surface light source, a reflection sheet 503 provided under the light guide plate 502 (on the opposite side to the liquid crystal display panel 507), and a group of functional optical sheets 504 to 506 provided on the light guide plate 502 (on the side of the liquid crystal display panel 507). The functional optical sheet group includes the diffusion sheet 504, the prism sheet 505, and the upper diffusion sheet 506. Note that in FIG. 21, the optical members are shown as if they are apart for the ease of illustrating the structure of the liquid crystal display device 500, but in practice the optical members are stacked in contact with one another.

In the conventional prism sheet, the top edge parts of the prism are susceptible to physical damages when it contacts other optical members and the surface is easily damaged. Once the surface of the prism is damaged, the picture screen of the liquid crystal display panel has for example unwanted light spots, which is likely to impair the optical effect of the prism sheet. Therefore, when the conventional prism sheet shown in FIG. 20 is used in a liquid crystal display device and an illumination device (backlight unit), a protection sheet (the upper diffusion sheet 506) must be provided between the liquid crystal display panel and the prism sheet as shown in FIG. 21.

When the prism sheet shown in FIG. 20 is used in an optical display device such as a liquid crystal display device (LCD), moiré tends to be generated on an optical display screen because of the plurality of prisms arranged parallel to one another. Therefore, a diffusion sheet is further laid on the prism sheet in order to improve the display quality.

An optical diffusion sheet used to reduce damages to the prism and moiré is disclosed by Japanese Patent No. 3431415. The optical diffusion sheet disclosed by the patent includes a transparent surface adjusting layer including binder resin on the surface of the optical member in the optical adjusting member such as a prism sheet. A plurality of beads are dispersed within the surface adjusting layer. In the disclosed optical diffusion sheet, the light diffusion surface is protected and the light diffusion effect is further improved by the surface adjusting layer.

In the optical diffusion sheet disclosed by Japanese Patent No. 3431415, however, the materials to be used for the optical member, the surface adjusting layer and the beads in practice are limited, and more specifically, materials having close refractive indexes are used. Therefore, the difference in the refractive index between the optical member, the surface adjusting layer and the beads cannot be sufficiently large, so that the effect of refracting incident light by the optical sheet is reduced and a sufficient light collecting characteristic is unlikely to result.

The problem of the degraded light collecting characteristic will be described more specifically. A material suitable for practical use as beads includes a plastic material or a transparent inorganic material such as oxide and nitride, and the refractive indexes of these materials are about in the range from 1.4 to 1.7. A material that may be used as a base member or an optical member is a resin material, and its refractive index in general is about in the range from 1.4 to 1.7. The refractive index of a resin material selectable in general is about 1.59 for polycarbonate, about 1.49 for acrylic resin, about 1.55 for styrene resin, and about 1.57 for polyethylene terephthalate. Therefore, when an optical adjusting layer of binder resin or the like is formed on the optical member (base member), the refractive index difference between the optical adjusting layer, the optical member and the beads is as small as about in the range from 0.1 to 0.2 even in consideration of combinations of materials. Therefore, the refraction effect between the optical adjusting layer, the optical member, and the beads is small, so that neither a sufficient light collecting characteristic nor diffusion characteristic is obtained. Note that in order to solve the problem, a material called “high refractive index material” has been developed, but the material is generally expensive.

An optical diffusion sheet disclosed by JP 08-146207 A has beads and the like dispersed in a prism sheet. However, the beads are dispersed in the prism sheet, and therefore light incident on the optical diffusion sheet is first subjected to a diffusion effect by the beads and then refracted at the surface of the prism. Therefore, moiré caused by the prism cannot be suppressed. Furthermore, the top of the prism is not protected and is more easily damaged.

### SUMMARY OF THE INVENTION

It is an object of the invention to provide an optical adjusting member capable of suppressing damages at the top edge of an optical member.

Another object of the invention is to provide an optical adjusting member that allows a diffusion effect sufficient for suppressing moiré to be obtained and the light collecting characteristic of incident light to be further improved.

The optical adjusting member according to the invention includes a base member, a plurality of lenses, and a light diffusion layer. The base member has optical transparency. The plurality of lenses are formed on the base member. The light diffusion layer is formed on the plurality of lenses and at least top edge parts of the lenses are buried in the light diffusion layer.

In the optical adjusting member according to the invention, at least the top edge parts of the lenses are buried in the light diffusion layer. Therefore, the lens surface (the surface of the optical member) is less susceptible to damages. The optical adjusting member according to the invention has a light collecting function by the lenses and a diffusion function by the light diffusion layer.

The light diffusion layer preferably has a plurality of bubbles dispersed therein.

In this way, the plurality of bubbles have a small refractive index, and therefore the refractive index of the light diffusion layer can be smaller than that in the case without such bubbles. Therefore, the refractive index difference between the lenses and the light diffusion layer can be increased, so that light can be more refracted at an interface between the lenses and the light diffusion layer. Therefore, the light collecting effect is improved.

The plurality of bubbles preferably include a plurality of first bubbles and a plurality of second babbles. The first bubbles have a size less than the wavelength of incident light, and the second bubbles have a size at least as large as the wavelength of incident light. Here, the “wavelength of incident light” refers to the wavelength of the incident light on the short wavelength side if the light has a width in the wavelength region for example like white light and to the central wavelength of incident light if the incident light is monochromatic light.

In this case, the first bubbles transmit incident light and do not scatter it. The first bubbles contribute to a reduction in the refractive index of the light diffusion layer and to the light collecting effect. On the other hand, the second bubbles scatter incident light and therefore contribute to the light collecting and diffusion effects. The presence of the first and second bubbles allows the optical adjusting member to have effective light collecting and diffusion functions instead of an excessive diffusion function.

The light diffusion layer is preferably made of plastic resin having optical transparency. The bubbles preferably have a refractive index smaller than the base member and lenses.

The light diffusion layer preferably includes a plurality of hollow particles and resin. The hollow particles include bubbles therein and have optical transparency. The resin has the plurality of hollow objects dispersed therein and has optical transparency.

The plurality of lenses each preferably extend in a predetermined direction and arranged parallel to one another. The lens preferably has a triangular or arch-shaped cross section. Herein, the “arch-shape” includes a semi-circular shape, a semi-elliptical shape, a curved shape having a plurality of curvatures such as a quadratic curve shape and a shape having a straight line segment in a part thereof.

The optical adjusting member preferably has a gap between the plurality of lenses and the light diffusion layer.

In this way, light incident on the optical adjusting member is first refracted at an interface between the lens surface and the gap. At the time, the incident light is refracted at the interface between the lens surface and the gap having sufficiently large difference in the refractive index, and therefore a sufficient refraction effect (light collecting effect) is obtained. Then, the light refracted at the interface between the lens surface and the gap is incident on the light diffusion layer and diffused. In this way, the optical adjusting member has light collecting and diffusion effects.

The plurality of lenses preferably include a plurality of first lenses and a plurality of second lenses. The plurality of second lenses have a greater height than that of the first linear lenses and top edge parts of the second lenses are buried in the light diffusion layer.

An illumination device according to the invention includes a light source, and the optical adjusting member described above. Light from the light source is incident on the optical adjusting member. The illumination device preferably further includes a light guide plate used to guide light from the light source to the optical adjusting member.

A liquid crystal display device according to the invention includes the above-described illumination device including the optical adjusting member and a liquid crystal display element laid on the optical adjusting member.

A method of manufacturing an optical adjusting member according to the invention includes the steps of preparing the base member, applying resin used to form the light diffusion layer on a surface of a roll to form a resin layer, contacting the resin layer formed on the roll surface to the top edge parts of the plurality of lenses while rotating the roll on the plurality of lenses, and curing the resin layer in contact with the top edge parts of the plurality of lenses, thereby forming the light diffusion layer.

Preferably in the step of forming the light diffusion layer, the resin layer formed on the roll surface is sequentially cured from the part contacted to the plurality of lenses by the rotation of the roll.

In this way, the light diffusion layer can be fixed to the plurality of lenses while the light diffusion layer is formed.

Preferably, the optical adjusting member includes a plurality of light diffusion layers, the roll has a plurality of grooves on a surface to be filled with the resin layer, and in the step of applying the resin layer, the resin is filled in the plurality of grooves.

### BRIEF DESCRIPTION OF THE DRAWINGS

FIG. 1 is a sectional view of an optical adjusting member according to a first embodiment of the invention;

FIG. 2 is an enlarged view of the region A in FIG. 1;

FIGS. 3A to 3D are views showing the steps of manufacturing the optical adjusting member shown in FIG. 1;

FIG. 4 is a sectional view of a liquid crystal display device including the optical adjusting member shown in FIG. 1;

FIG. 5A is a sectional view of an optical adjusting member according to a second embodiment of the invention;

FIG. 5B is a sectional view of hollow objects included in the optical adjusting member;

FIG. 6 is a sectional view of a liquid crystal display device including the optical adjusting member shown in FIG. 5A;

FIG. 7 is a sectional view of an optical adjusting member according to a third embodiment of the invention;

FIG. 8 is a sectional view of another optical adjusting member different from those in FIGS. 1, 5A, and 7;

FIG. 9 is a sectional view of another liquid crystal display device different from those in FIGS. 4 and 6;

FIGS. 10A and 10B are a perspective view and a side view of an optical adjusting member according to a fourth embodiment of the invention;

FIG. 11 is a flowchart for use in illustrating the steps in the process of manufacturing the optical adjusting member in FIG. 10A;

FIG. 12 is a sectional view of a manufacturing device for the optical adjusting member shown in FIG. 10A;

FIG. 13 is a sectional view of a liquid crystal display device including the optical adjusting member in FIG. 10A;

FIG. 14 is a perspective view of an optical adjusting member according to a fifth embodiment of the invention;

FIGS. 15A to 15C are sectional views of other optical adjusting members different from those in FIGS. 10A and 14;

FIG. 16 is a perspective view of another optical adjusting member different from those in FIGS. 10A, and 14, and 15;

FIG. 17 is a perspective view of another optical adjusting member different from those in FIGS. 10A, and 14 to 16;

FIG. 18 is a perspective view of another optical adjusting member different from those in FIGS. 10A, and 14 to 17;

FIG. 19 is a perspective view of another optical adjusting member different from those in FIGS. 10A, and 14 to 18;

FIG. 20 is a perspective view of a conventional prism sheet; and

FIG. 21 is a sectional view of a conventional liquid crystal display device.

### DESCRIPTION OF THE PREFERRED EMBODIMENTS

Now, embodiments of the invention will be described in detail in conjunction with the accompanying drawings, in which the same or corresponding portions are denoted by the same reference characters and their description is not repeated.

### First Embodiment

Optical Adjusting Sheet

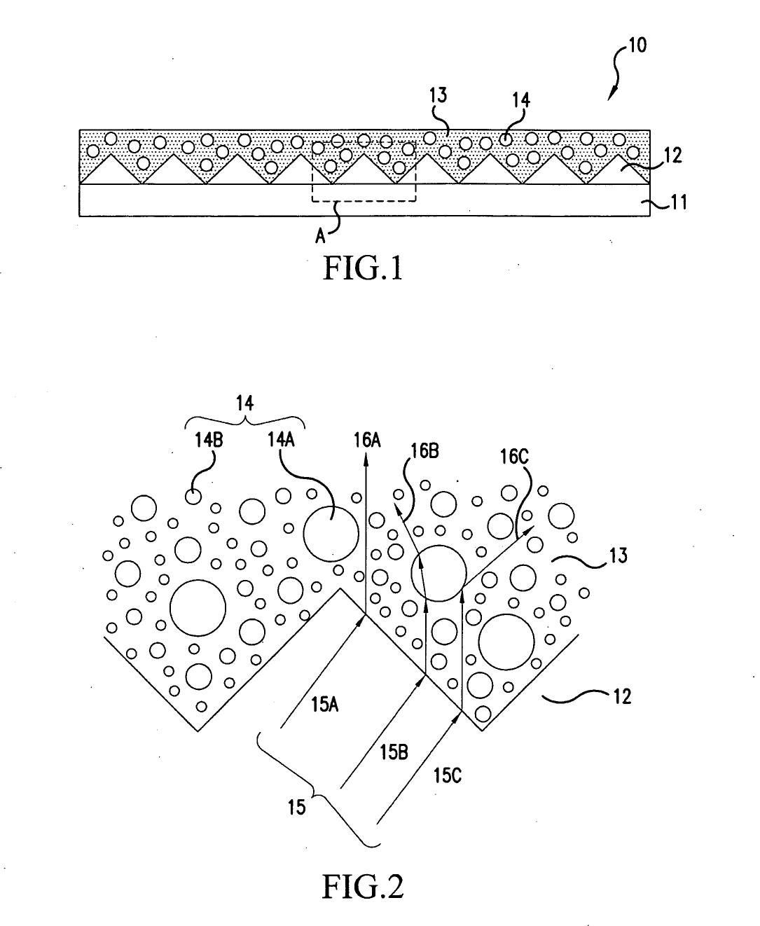

FIG. 1 is a schematic sectional view of an optical adjusting sheet as an optical adjusting member according to a first embodiment of the invention. With reference to FIG. 1, the optical adjusting sheet 10 includes a sheet type base member 11, a plurality of prisms 12 provided on the base member 11 and a light diffusion layer 13 formed on the plurality of prisms 12.

The base member 11 has optical transparency. An example of the material of the base member 11 may include resin such as polyethylene terephthalate (PET), polyethylene naphthalate, polystyrene, polycarbonate (PC), polyolefin, polypropylene, and cellulose acetate, and an inorganic transparent material such as glass. An arbitrary shape may be employed for the base member 11, and it may be a sheet type or a plate type having a thickness about in the range from 1 mm to 100 mm. Note that when the sheet type base member 11 is used, the base member 11 preferably has a thickness in the range from 30 μm to 500 μm in consideration of working readiness and handling ability.

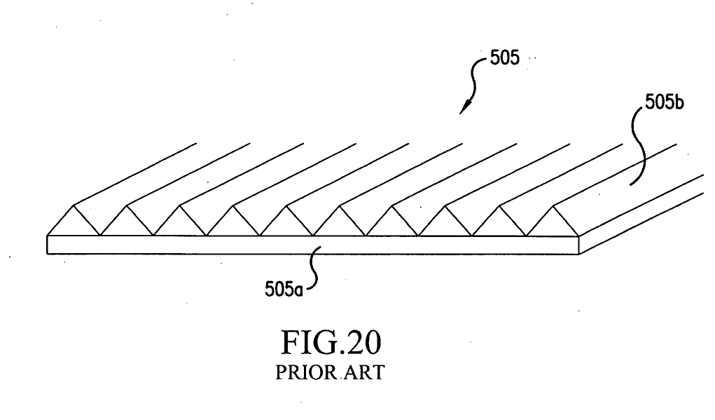

The prism 12 has the same structure as that of the prism 505b shown in FIG. 20 and is a linear lens having a triangular section orthogonal to the lengthwise direction. The prisms 12 are for example made of resin with optical transparency such as ultraviolet curing resin like acrylic resin. The prism 12 may be formed using the same material as the base member 11 or formed integrally with the base member 11.

The plurality of prisms 12 are arranged in the direction orthogonal to the lengthwise direction. In FIG. 1, adjacent prisms 12 are in contact with each other, while adjacent prisms 12 may be apart from each other with a gap therebetween. The plurality of prisms may be provided at equal intervals or in a random manner.

In short, the size and pitch of the prisms 12 can be changed as required depending on the necessary optical characteristic, use, workability and the like. For example, the prism 12 preferably has a height about in the range from 7 μm to 50 μm in consideration of workability (handling ability or the like) in forming the light diffusion layer on the plurality of prisms 12.

When the optical adjusting sheet 10 is used for a side light type liquid crystal display device, the vertical angle of the prism 12 is preferably in the range from 60° to 120° in consideration of the light collecting effect and diffusion effect to incident light. The vertical angle of the prism 12 is set in the above-described range, so that light output from the light guide plate can effectively be refracted at an interface between the prism 12 and the light diffusion layer 13 of the optical adjusting sheet 10. On the other hand, when the vertical angle of the prism 12 is outside the above-described range, it is difficult to collect incident light in the normal direction to the optical adjusting sheet (thickness-wise direction) at the interface between the prism 12 and the light diffusion layer 13 of the optical adjusting sheet 10.

Light diffusion layer 13 is made of resin and glass. When the layer is made of glass, for example a sol-gel method is employed. Preferably, the light diffusion layer 13 is formed using plastic resin having optical transparency. An example of the plastic resin may include ultraviolet curing resin such as urethane resin, styrene resin, epoxy resin, silicone resin, polyester resin, fluororesin, polyamide resin, and acrylic resin.

The light diffusion layer 13 further has a plurality of bubbles 14 dispersed therein. The plurality of bubbles 14 have different sizes. More specifically, the light diffusion layer 13 contains bubbles smaller in size than the wavelength of incident light (hereinafter referred to as “small bubbles”) and bubbles larger in size than the wavelength of incident light (hereinafter referred to as “large bubbles”). Herein, the “wavelength of incident light” refers to the wavelength of incident light on the short-wavelength side for light having a width in a wavelength region such as white light and to the central wavelength of incident light for monochromatic light. When the incident light is visible light, the small bubbles have a size less than the wavelength (about 0.4 μm) of the visible light on the short wavelength side, and the large bubbles have a size equal to or larger than the wavelength (about 0.4 μm) of the visible light on the short wavelength side.

The size of the bubbles 14 is for example measured by the following method. A predetermined sectional region of the light diffusion layer 13 is observed using a transmission electron microscope (TEM). In each of a plurality of bubbles (such as 50 bubbles) in the observed region, the diameter is measured. The measured diameter is defined as the size of the bubble.

The size of the bubble 14 is for example preferably in the range from 0.01 μm to 10 μm. The total volume ratio of the bubbles 14 to the light diffusion layer 13 is preferably in the range from 10% to 90%. The bubbles may be typically made of air or any arbitrary gas having a low refractive index equivalent to air.

As described above, in the optical adjusting sheet 10, the light diffusion layer 13 having the bubbles 14 dispersed therein is formed on the plurality of prisms 12 (lenses). Since the refractive index of the bubbles 14 is small and the small bubbles having a size less than the wavelength of incident light on the short wavelength side are dispersed within the light diffusion layer 13, the effective refractive index of the light diffusion layer 13 is smaller than the case without the bubbles 14. Therefore, a sufficient refraction effect is provided at an interface between the prisms 12 and the light diffusion layer 13 in the optical adjusting sheet 10, so that the light collecting characteristic for the incident light improves.

Furthermore, in the optical adjusting sheet 10, the large bubbles having a size equal to or greater than the wavelength of incident light on the short wavelength side are dispersed within the light diffusion layer 13, so that the incident light can be provided with an appropriate scattering effect by the large bubbles.

Hereinafter, the principle of how the light collecting and scattering (dispersion) effects are provided in the optical adjusting sheet 10 will be described in detail with reference to FIG. 2.

FIG. 2 is an enlarged view of an interface between the prisms 12 and the light diffusion layer 13. As shown in FIG. 2, incident light 15 in FIG. 2 is for example passed through the interface between the prism 12 (with a refractive index n1) and the light diffusion layer 13. (The resin that forms the light diffusion layer 13 has a refractive index n2). At the time, the refractive index n2′ of the light diffusion layer 13 (the refractive index of the resin including the small bubbles 14B) is lower than the refractive index n2 as described above, and the effective refractive index difference between the prism 12 and the light diffusion layer 13 (|n1−n2′|) is sufficiently large. Therefore, the light 15 incident on the interface between the prism 12 and the light diffusion layer 13 is sufficiently refracted at the interface, so that a sufficient light collecting effect can be obtained.

A light component 16A of the light component passed through the interface between the prism 12 and the light diffusion layer 13 that is not incident to the large bubble 14 in the light diffusion layer 13 advances in the thickness-wise direction (light collecting direction) of the optical adjusting sheet 10 without being scattered. Note that the waveform of the light component passed in the light diffusion layer 13 is larger than the size of the small bubbles 14B and therefore the light passed in the light diffusion layer 13 passes by the small bubbles 14B without being scattered.

On the other hand, a part of the light component passed through the interface between the prism 12 and the light diffusion layer 13 that is incident to the large bubble 14A (if the bubble is made of air, the refractive index n3 is 1.0) in the light diffusion layer 13 is reflected at the interface between the light diffusion layer 13 and the large bubble 14A (reflected light 16C), and another part is refracted through the interface (refracted light 16B) as shown in FIG. 2. By the reflection and refraction functions, a part of the light incident to the light diffusion layer 13 is scattered. In this way, the optical adjusting sheet 10 has appropriate light collecting and diffusion functions to the incident light.

In the optical adjusting sheet 10, the light diffusion layer 13 is formed on the plurality of prisms 12, and therefore the prisms 12 (lens surfaces) are susceptible to damages. Therefore, the optical adjusting sheet 10 has the light collecting function, diffusion function, and protection function at the same time.

Note that in the optical adjusting sheet according to the invention, the light diffusion layer may be made of the same material as the base member or the prisms.

Method of Manufacturing Optical Adjusting Sheet

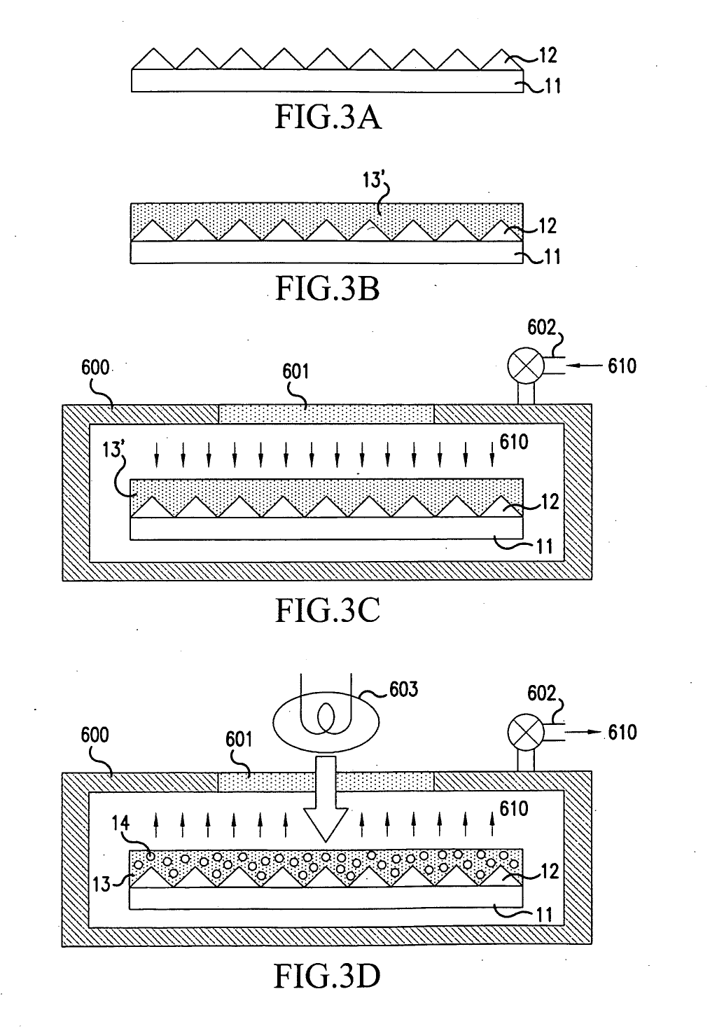

Now, an example of a method of manufacturing the optical adjusting sheet 10 will be described with reference to FIGS. 3A to 3D.

A plurality of prisms 12 are formed on a prepared base member 11. A die having a ridge-groove pattern on a surface thereof that correspond to the ridge-groove shape of the plurality of prisms 12 is prepared. The ridges and grooves on the surface of the die are formed by cutting. Then, the ridge-groove surface of the die and the base member 11 are opposed to each other, ultraviolet curing resin is filled therebetween, and the ultraviolet curing resin is subjected to ultraviolet irradiation and cured. Then, the base member 11 is removed from the die. In this way, the plurality of prisms 12 are formed on the base member 11 (see FIG. 3A).

Note that the following method may be employed for manufacturing the prisms 12 other than the above. For example, a die having a predetermined ridge-groove pattern formed on its surface is heated and pressed against a base member, so that the ridge-groove pattern of the die is transferred onto the surface of the base member (thermal transfer). By the thermal transfer method, the prisms 12 can directly be formed on the base member. Alternatively, a well-known method such as extrusion molding and press-molding or injection molding (by which molten resin is injected to the die having the base member or the lenses formed therein) may be employed.

Then, the plurality of prisms 12 are coated with ultraviolet curing resin 13′ by roll coating (see FIG. 3B). At the time, the ultraviolet curing resin 13′ is applied in a predetermined thickness and the plurality of prisms 12 are filled with the ultraviolet curing resin. At the time, the ultraviolet curing resin is filled in the recesses between the prisms 12 so that the surface of the ultraviolet curing resin is approximately flat.

Then, the base member 11 having the plurality of prisms 12 coated with the ultraviolet curing resin 13′ is mounted in a high pressure chamber 600 before the ultraviolet curing resin 13′ is cured as shown in FIG. 3C. As shown in FIG. 3C, an ultraviolet irradiation window 601 for passing ultraviolet light is provided on the upper surface of the high pressure chamber 600. The high pressure chamber 600 is provided with a pipe system 602 used to adjust pressure by letting gas in and out from the high pressure chamber 600.

Carbon dioxide 610 is introduced into the high pressure chamber 600 through the pipe system 602. The temperature and pressure in the high pressure chamber 600 are adjusted so that the temperature and pressure of the carbon dioxide each exceed the critical point and reach a supercritical state. For example, the temperature in the high pressure chamber 600 is set to 50° C. and the pressure is set to 10 MPa. By the operation, the carbon dioxide 610 reaches a supercritical state and dissolves into the ultraviolet curing resin 13′. Note that the gas introduced into the high pressure chamber 600 may be air, nitrogen or the like other than carbon dioxide. The pressure in the high pressure chamber 600 may be adjusted as required in the range from 1 MPa to 40 MPa.

Then, as shown in FIG. 3D, the carbon dioxide 610 in the high pressure chamber 600 is partly leaked through the pipe system 602, so that the pressure in the high pressure chamber 600 is abruptly lowered. By the operation, the carbon dioxide dissolved in the ultraviolet curing resin 13′ foams, and as shown in FIG. 3D, bubbles 14 are formed in the ultraviolet curing resin 13′. After the bubbles 14 are formed, the ultraviolet curing resin 13′ is subjected to ultraviolet irradiation through the ultraviolet irradiation window 601 by an ultraviolet irradiation device 603 provided outside the high pressure chamber 600, so that the ultraviolet curing resin 13 is cured.

By the above-described method, the light diffusion layer 13 made of the ultraviolet curing resin having the plurality of bubbles 14 dispersed therein is formed. Note that the diameter (size), distribution, and volume ratio of the bubbles 14 can be adjusted by controlling the temperature and pressure when the gas such as the carbon dioxide is dissolved into the ultraviolet curing resin under pressure in a container such as a high pressure chamber, especially by controlling conditions for pressure difference and pressure variation when the foaming is generated by lowering the pressure in the container. Note that the optical adjusting sheet 10 can be produced by other methods.

Illumination Device and Liquid Crystal Display Device

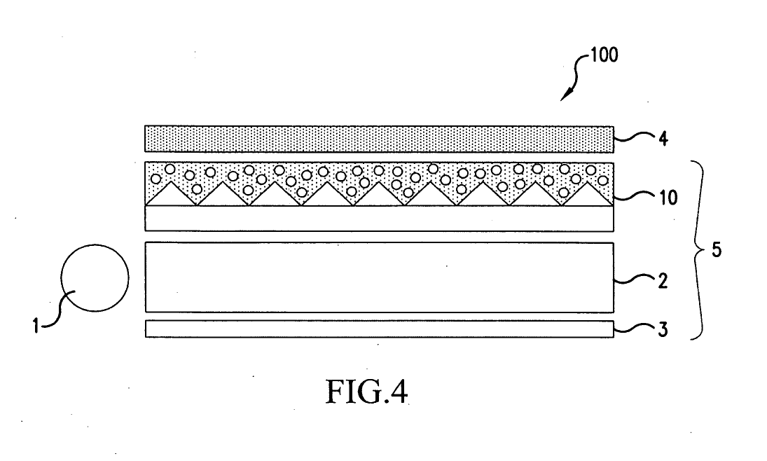

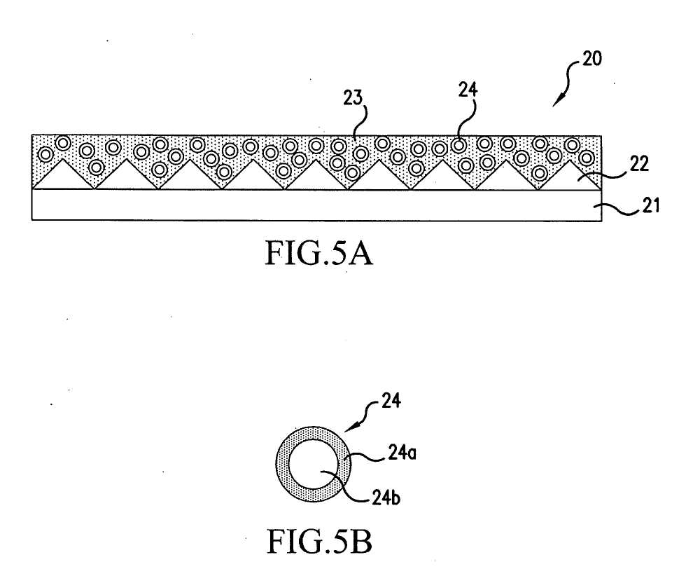

FIG. 4 is a schematic view of a liquid crystal display device according to an embodiment of the invention.

The liquid crystal display device 100 includes a backlight unit 5 (illumination device) and a liquid crystal display panel 4 (liquid crystal display element) laid on the backlight unit 5. The backlight unit 5 includes a light source 1 (LED: white light), a light guide plate 2 that changes light radiated from the light source 1 into a surface light source, a reflection sheet 3 provided under the light guide plate 2 (on the opposite side to the liquid crystal display panel 4), and an optical adjusting sheet 10 provided on the light guide plate 2 (on the side of the liquid crystal display panel 4). In FIG. 4, the optical members are illustrated as if they are apart from one another for the ease of illustrating the structure of the liquid crystal display device 100, but in practice they are stacked in contact with one another.

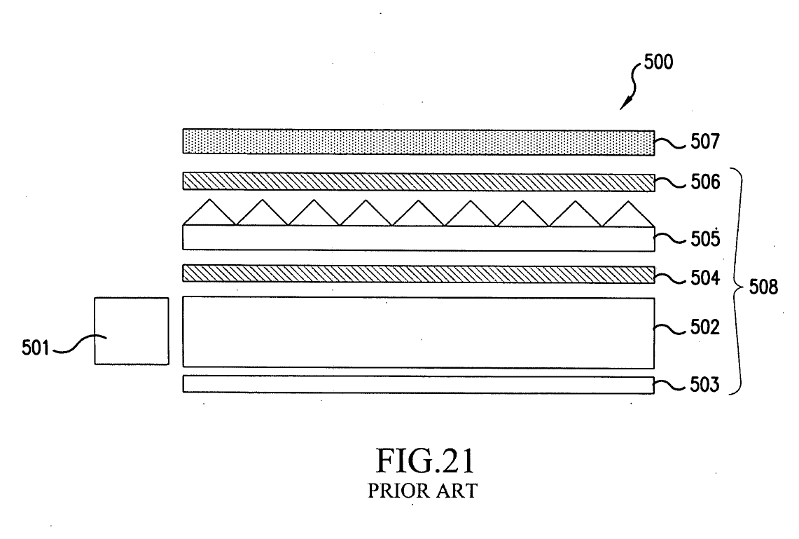

As described above, since the optical adjusting sheet 10 has the light collecting function, diffusion function, and protection function at the same time, the use of the single optical adjusting sheet 10 provides the same effect as that of the functional sheet group consisting of the diffusion sheet 504, the prism sheet 505 and the protection sheet 506 in a conventional liquid crystal display device as shown in FIG. 21. Therefore, as can be understood from comparison between FIGS. 4 and 21, in the liquid crystal display device 100, the conventional functional sheet group consisting of the three optical sheets can be replaced by the single optical adjusting sheet 10, so that the liquid crystal display device 100 and the backlight unit 5 can be reduced in thickness and the cost can be lowered.

### Inventive Example 1

An example of the optical adjusting sheet 10 was prepared. Hereinafter, the optical adjusting sheet will be referred to as “optical adjusting sheet in Inventive Example 1.” The base member was a polyethylene terephthalate (PET) sheet having a refractive index of 1.57 and a thickness of 50 μm. The prisms were made of ultraviolet curing resin with a refractive index of 1.59. As for the size of a section thereof, the vertical angle was 90°, the base had a length of 50 μm, the height was 25 μm, and the pitch was 50 μm. The light diffusion layer was made of aromatic acrylate resin having a refractive index of 1.56 and a plurality of bubbles having sizes from 0.05 μm to 5.0 μm. The total volume ratio of the bubbles relative to the light diffusion layer was 70%. The refractive index of the light diffusion layer was 1.17 in the optical adjusting sheet in Inventive Example 1, and the effective refractive index difference between the light diffusion layer and the prisms 12 (with a refractive index of 1.59) was as large as 0.42.

The optical adjusting sheet in Inventive Example 1 was mounted to the liquid crystal display device shown in FIG. 4 and evaluated for the optical characteristic. As a result, sufficient luminance was obtained at the liquid crystal display surface and no moiré was observed. This was probably because bubbles in various sizes (about 0.05 μm to 5 μm) were dispersed in the light diffusion layer in the optical adjusting sheet in Inventive Example 1, so that appropriate scattering (diffusion) and light collecting effects were provided to light incident to the optical adjusting sheet.

### Second Embodiment

In the first embodiment, the plurality of bubbles were dispersed in the light diffusion layer, a plurality of hollow particles may be used instead of the plurality of bubbles. When hollow particles are used, after the inner diameter and dispersion ratio thereof are selected in advance, and the particles are be dispersed, the light diffusion layer can be formed. Therefore, the light diffusion effect of the light diffusion layer and the light collecting effect as the optical adjusting sheet may previously be designed, so that control according to the design may readily be achieved, which is preferable in terms of manufacture.

Now, an optical adjusting sheet according to a second embodiment of the invention will be described.

Optical Adjusting Sheet

FIG. 5A is a schematic sectional view of an optical adjusting sheet according to the second embodiment and FIG. 5B is a schematic sectional view of hollow beads.

As shown in FIG. 5A, an optical adjusting sheet 20 includes a sheet type base member 21, a plurality of prisms 22 (lenses) provided on the base member 21, and a light diffusion layer 23 formed on the plurality of prisms 22. Note that the structures (shapes, sizes and the like) and materials of the base member 21 and the prisms 22 are the same as those in the first embodiment.

The light diffusion layer 23 includes resin and a plurality of hollow beads dispersed in the resin. The resin is the same as that of the light diffusion layer 13.

As shown in FIG. 5B, the hollow beads 24 are each made of an outer shell 24a and a hollow part 24b (bubble) in the outer shell 24a, and the hollow part 24b contains a gas such as air. Therefore, in the hollow bead 24, the refractive index difference between the outer shell 24a and the hollow part 24b is large.

The outer shell 24a has optical transparency. The outer shell 24a is made of plastic resin or any of various kinds of oxide and nitride as a transparent inorganic substance. More specifically, it is made of a transparent inorganic substance such as oxide or nitride such as silica, titania, alumina, and zirconia, or acrylic resin, styrene resin or the like.

The plurality of hollow beads 24 include two kinds of hollow beads having different sizes. More specifically, they are a plurality of hollow beads having an inner diameter less than the short wavelength of incident light (0.4 μm for visible light) (hereinafter referred to as “small hollow beads”) and a plurality of hollow beads having an inner diameter greater than the short wavelength of the incident light (hereinafter referred to as “large hollow beads”).

The refractive index of the light diffusion layer can be set by selecting the inner diameter and diffusion ratio of the small hollow beads. The light diffusion effect is set by selecting the inner diameter and dispersion ratio of the large hollow beads. The inner diameters and dispersion ratios of these large and small hollow beads can be set independently, so that the refractive index and diffusion effect can readily be controlled.

The inner diameter of the hollow beads can be obtained for example by the following method. A hollow bead (before being dispersed within the resin) is observed using a scanning electron microscope (SEM), the particle diameter thereof is measured in a plurality of locations and the average grain size is obtained. Then, the hollow bead is crushed and observed using the SEM, and the thickness of the outer shell is measured in a plurality of locations to obtain the average thickness. The difference between the obtained average particle diameter and average thickness is defined as the inner diameter of the hollow bead.

According to the same principle as the principle of how the light collecting and diffusion effects are obtained described in connection with the first embodiment, the small hollow beads mainly lower the effective refractive index of the light diffusion layer 23 and the large hollow beads mainly scatter (diffuse) incident light.

As for the mixing ratio of all the hollow beads 24 to the light diffusion layer 23, the ratio of the hollow beads relative to 100 parts by weight of the resin is preferably 10 to 300 parts by weight in consideration of the light diffusion characteristic and optical transparency of incident light.

In the optical adjusting sheet 20, the hollow beads 24 having the hollow part 24b having a size less than the wavelength of incident light on the short wavelength side (with a refractive index of 1.0 for air) is present in the light diffusion layer 23, and therefore the effective refractive index of the light diffusion layer 23 can be lowered similarly to the optical adjusting sheet 10, and the light collecting characteristic to the incident light can be improved. In the optical adjusting sheet 20, the large hollow beads having a larger hollow part than the wavelength of incident light on the short waveform side is dispersed in the light diffusion layer 23 and therefore the effect of scattering (diffusion) by the large hollow beads is obtained as well. More specifically, in the optical adjusting sheet 20 according to the embodiment, incident light can be subjected to appropriate scattering and light collecting effects similarly to the optical adjusting sheet 10.

The optical adjusting sheet 20 includes the light diffusion layer 23 formed on the plurality of prisms 22, and therefore the prisms 22 (lenses) are less susceptible to damages. Therefore, the optical adjusting sheet 20 includes the light collecting function, diffusion function, and protection function at the same time similarly to the optical adjusting sheet 10.

Note that the optical characteristics of the optical adjusting sheet 20 including the light collecting characteristic and diffusion characteristic can be adjusted by adjusting the combination of materials to form the hollow beads 24 and the light diffusion layer 23, the inner diameter distribution of the hollow beads 24, the thickness of the outer shell 24a, the mixing ratio of the hollow beads 24 in the light diffusion layer or by adjusting the combination of these conditions as required.

In the foregoing, the hollow beads including a gas in the hollow part are used, while any other hollow particles such as vacuum beads whose hollow part is in a vacuum state or porous beads may be used. Using the hollow particles, the size or additive amount of bubbles can readily be adjusted.

Method of Manufacturing Optical Adjusting Sheet

Now, a method of manufacturing an optical adjusting sheet 20 will be described. A plurality of prisms 22 are formed on the base member 21 similarly to the optical adjusting sheet 10.

Then, ultraviolet curing resin (such as acrylic resin) including hollow beads 24 is applied on the plurality of prisms 22 by roll-coating. At the time, the ultraviolet curing resin is applied, so that the recesses between the prisms 22 are filled with the acrylic resin and the surface of the ultraviolet curing resin is approximately flat. Note that the hollow beads 24 may be dispersed within the ultraviolet curing resin using a known dissolver device or the like. Then, the ultraviolet curing resin thus applied is subjected to ultraviolet irradiation and cured, so that the light diffusion layer 23 is formed on the lens group consisting of the plurality of prisms 22. In this way, the optical adjusting sheet 20 is produced.

Illumination Device and Liquid Crystal Display Device

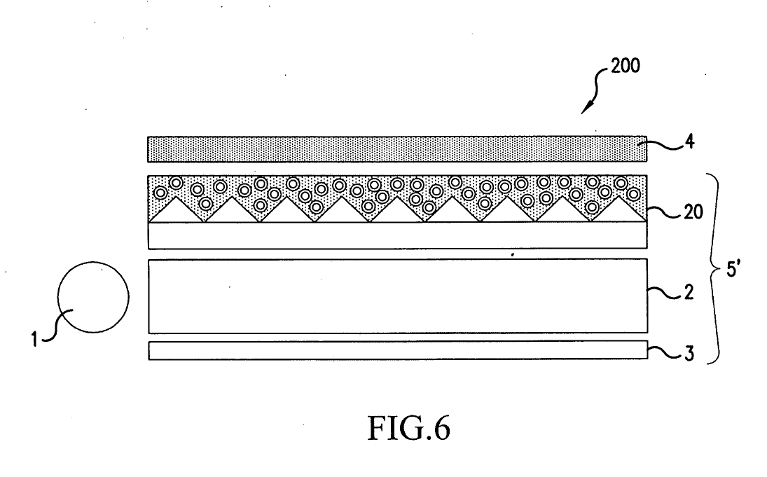

FIG. 6 is a schematic view of a liquid crystal display device according to the second embodiment. With reference to FIG. 6, in the liquid crystal display device 200, the optical members other then the optical adjusting sheet 20 are the same as those in the liquid crystal display device 100. Note that in FIG. 6, the optical members are illustrated as if they are apart from one another for the ease of illustrating the structure of the liquid crystal display device 200, but in practice they are stacked in contact with one another.

Since the optical adjusting sheet 20 has the light collecting function, diffusion function, and protection function at the same time, the use of the single optical adjusting sheet 20 provides the same effect as that by the functional sheet group consisting of the diffusion sheet 504, the prism sheet 505 and the protection sheet 506 in a conventional liquid crystal display device as shown in FIG. 21. Therefore, in the liquid crystal display device 200, as can be understood from comparison between FIGS. 6 and 21, the conventional functional sheet group consisting of the three optical sheets can be replaced by the single optical adjusting sheet 20, so that the liquid crystal display device 200 and the backlight unit 5′ can be reduced in thickness and the cost can be reduced.

The surface hardness of the hollow beads is preferably greater than the hardness of the base member 21 and the prisms 22. In this way, the surface of the prisms 22 is buried in the light diffusion layer 23 including the hard hollow beads 24, and therefore the prisms 22 can be protected. In the liquid crystal display device having the optical adjusting sheet 20 described above on the light guide plate or light diffusion plate and a liquid crystal panel provided in close contact thereon, the optical members can be prevented from being damaged or worn as they are contacted and pressed by the liquid crystal panel or by friction.

Note that when the surface of the light diffusion layer is substantially flat, the wearing or damages of the plurality of lenses can be suppressed, while the surface shape of the light diffusion layer may be any arbitrary shape as long as the protection effect for the plurality of lenses is not impaired.

### Inventive Example 2

An example of the optical adjusting sheet 20 was produced by the above-described method. Hereinafter, the optical adjusting sheet thus produced will be referred to as “optical adjusting sheet in Inventive Example 2.” The base member of the optical adjusting sheet in Inventive Example 2 was a polyethylene terephthalate (PET) sheet having a refractive index of 1.57 and a thickness of 50 μm. The light diffusion layer was made of ultraviolet curing type acrylic resin having a refractive index of 1.56 and a thickness of 30 μm. Hollow silica beads from CATALYSTS & CHEMICALS IND. CO., LTD were size-classified and used as the small and large hollow beads. The hollow part of each hollow bead is filled with air (refractive index: 1.0) and the refractive index of the outer shell was 1.46. The average inner diameter of the small hollow beads was 0.06 μm, and the average inner diameter of the large hollow beads was 4 μm. These average inner diameters were obtained by the following method. Among a plurality of hollow beads used for an optical adjusting sheet, 50 small beads and 50 large beads were selected, the grain sizes (diameters) of the selected beads were measured and the average was obtained. Each bead was crushed and the thickness of the outer shell was measured in a plurality of locations, so that the average of the measured thickness was obtained. The average inner diameter was obtained based on the grain size and the average thickness thus obtained.

The mixing ratio of the small hollow beads relative to 100 parts by weight of the acrylic resin was 45 parts by weight, and the mixing ratio of the large hollow beads relative to 100 parts by weight of the acrylic resin was 5 parts by weight.

The optical adjusting sheet in Inventive Example 2 thus produced was mounted to the liquid crystal display device 200 shown in FIG. 6 and evaluated for the optical characteristic. As a result, sufficient luminance was obtained at the liquid crystal display surface, and no moiré was observed. This was probably because the two kinds of hollow beads 24 having different sizes were dispersed in the light diffusion layer 23 of the optical adjusting sheet 20, so that appropriate scattering (diffusion) and light collecting effects were provided to light incident to the optical adjusting sheet 20.

### Third Embodiment

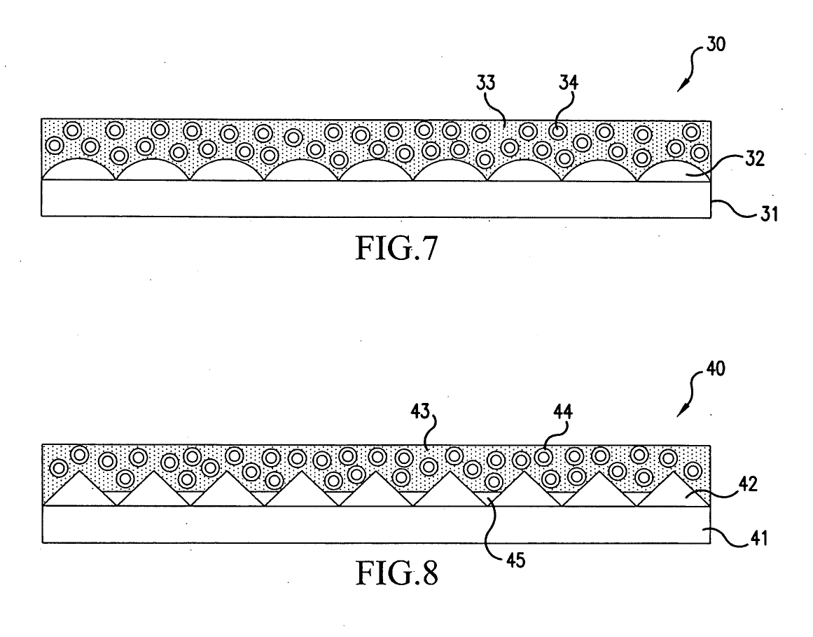

According to a third embodiment of the invention, the shape of the optical members (lenses) formed on a base member is different from that in the second embodiment. More specifically, a linear lens (prism) having a triangular section orthogonal to the lengthwise direction is used in the second embodiment, while according to the third embodiment, a linear lens (hereinafter also referred to as “cylindrical lens”) having an arch-shaped section orthogonal to the lengthwise direction is used. FIG. 7 is a schematic sectional view of an optical adjusting sheet according to the embodiment.

Optical Adjusting Sheet

As shown in FIG. 7, the optical adjusting sheet 30 includes a sheet-type base member 31, a plurality of cylindrical lenses 32 provided on the base member 31, and a light diffusion layer 33 formed on the plurality of cylindrical lenses 32 and having a plurality of hollow beads 34 dispersed therein. Note that the material of the base member 31 is the same as that in the second embodiment. The materials and the sizes of the light diffusion layer 33 and the hollow beads 34 and the mixing ratio of the hollow beads 34 relative to the light diffusion layer 33 are the same as those in the second embodiment.

The hollow beads 34 include small hollow beads having an average inner diameter smaller than the wavelength of incident light on the short wavelength side and large hollow beads having an average inner diameter larger than the wavelength of the incident light on the short wavelength side.

The cylindrical lenses 32 are linear lenses that extend in a predetermined direction (direction orthogonal to the surface of the sheet in FIG. 7) and have an arch-shaped section orthogonal to the lengthwise direction. The cylindrical lenses 32 are for example made of ultraviolet curing resin similarly to the prisms 12 and 22. The plurality of cylindrical lenses 32 are arranged in the direction orthogonal to the lengthwise direction on the base member 31. In FIG. 7, adjacent cylindrical lenses 32 are in contact with one another, but they may be apart from one another. The size and pitch of the cylindrical lenses 32 may be changed as required depending on the required optical characteristic, use, workability and the like. For example, in consideration of workability when a light diffusion layer is formed on the plurality of cylindrical lenses 32, the height of the cylindrical lenses 32 is preferably in the range from 7 μm to 50 μm.

In the optical adjusting sheet 30, the hollow parts (if filled with air, the refractive index is 1.0) of the hollow beads 34 are present in the light diffusion layer 33, and therefore the effective refractive index of the light diffusion layer 33 can be lowered similarly to the first and second embodiments, and the light collecting characteristic to the incident light can be improved. In the optical adjusting sheet 30, the large hollow beads are dispersed within the light diffusion layer 33 and therefore the effect of scattering (diffusion) by the large hollow beads is obtained as well. More specifically, in the optical adjusting sheet 30 according to the embodiment, appropriate scattering and light collecting effects are provided to incident light. Furthermore, in the optical adjusting sheet 30, the light diffusion layer 33 is formed on the plurality of cylindrical lenses 32, so that the cylindrical lenses 32 (lens surfaces) are not susceptible to damages. Therefore, the optical adjusting sheet 30 has the light collecting function, diffusion function, and protection function at the same time similarly to the first and second embodiments.

Note that according to the method of manufacturing the optical adjusting sheet 30, when the plurality of cylindrical lenses 32 are formed on the base member 31, a die having ridges and grooves on a surface thereof that correspond to the shape of the plurality of cylindrical lenses 32 is prepared. Other than the above, the optical adjusting sheet 30 is produced similarly to the second embodiment.

Similarly to the first and second embodiments, the optical adjusting sheet 30 is mounted to a side light type liquid crystal display device. More specifically, the optical adjusting sheet 30 is mounted in the liquid crystal display device 200 shown in FIG. 6 instead of the optical adjusting sheet 20.

As described above, the optical adjusting sheet 30 has the light collecting function, diffusion function, and protection function at the same time, the use of the single optical adjusting sheet 30 provides the same effect as that of the functional sheet group consisting of the diffusion sheet 504, the prism sheet 505 and the protection sheet 506 in the conventional liquid crystal display device as shown in FIG. 21. Therefore, in the liquid crystal display device using the optical adjusting sheet 30, the conventional functional sheet group consisting of the three optical sheets can be replaced by the single optical adjusting sheet 30, so that the liquid crystal display device and the backlight unit can be reduced in thickness and the cost can be reduced.

### Inventive Example 3

An example of the optical adjusting sheet 30 was produced by the above-described method. Hereinafter, the optical adjusting sheet thus produced will be referred to as “optical adjusting sheet in Inventive Example 3.” The base member of the optical adjusting sheet in Inventive Example 3 was a polyethylene terephthalate (PET) sheet having a refractive index of 1.57 and a thickness of 50 μm. The cylindrical lenses have a width of 24 μm and a height of 12 μm, and a section thereof has a semicircular shape whose radius of curvature was 12 μm. The pitch of the cylindrical lenses was 24 μm. The other structure was the same as that of Inventive Example 2.

The optical adjusting sheet in Example 3 thus produced was mounted to the liquid crystal display device 200 shown in FIG. 6 instead of the optical adjusting sheet 20 and evaluated for the optical characteristic. As a result, sufficient luminance was obtained at the liquid crystal display surface, and no moiré was observed. This was probably because the two kinds of hollow beads 34 having different sizes were dispersed in the light diffusion layer 33 of the optical adjusting sheet 30, so that appropriate scattering (diffusion) and light collecting effects were provided to light incident to the optical adjusting sheet 30.

The optical adjusting sheets according to the first to third embodiments may have a gap between the plurality of lenses and the light diffusion layer.

With reference to FIG. 8, an optical adjusting sheet 40 includes a sheet type base member 41, a plurality of prism type linear lenses (prisms) 42 formed on the base member 41, and a light diffusion layer 43 formed on the plurality of prisms 42 and having hollow beads 44 dispersed therein.

A gap 45 is formed at each of the grooves (bottoms) between the prisms 42. Except for the presence of the gap 45 at each of the grooves between the prisms 42, the structure is the same as that of the optical adjusting sheet 20.

The gaps 45 at the grooves between the prisms 42 can be formed by adjusting the condition for applying the material of the light diffusion layer 43 so that the material of the light diffusion layer 43 is not filled in the grooves between the prisms 42 when the light diffusion layer 43 is formed on the prisms 42.

In the optical adjusting sheet 40, the refractive index difference increases not only at an interface between the light diffusion layer 43 and the hollow part of the hollow bead 44 but also at interfaces between the prism 42 and the gap 45 and between the gap 45 and the light diffusion layer 43. Therefore, incident light may further be provided with a scattering effect and a light collecting effect. Note that instead of the hollow beads 44, bubbles may be dispersed in the light diffusion layer 43 as in the optical adjusting sheet 10.

According to the first to third embodiments, the optical adjusting sheets are each applied to a side light type liquid crystal display device and a backlight unit (illumination device), but the invention is not limited to the arrangement. The optical adjusting sheets according to the first to third embodiments may be applied to a direct type backlight unit and a liquid crystal display device including the unit.

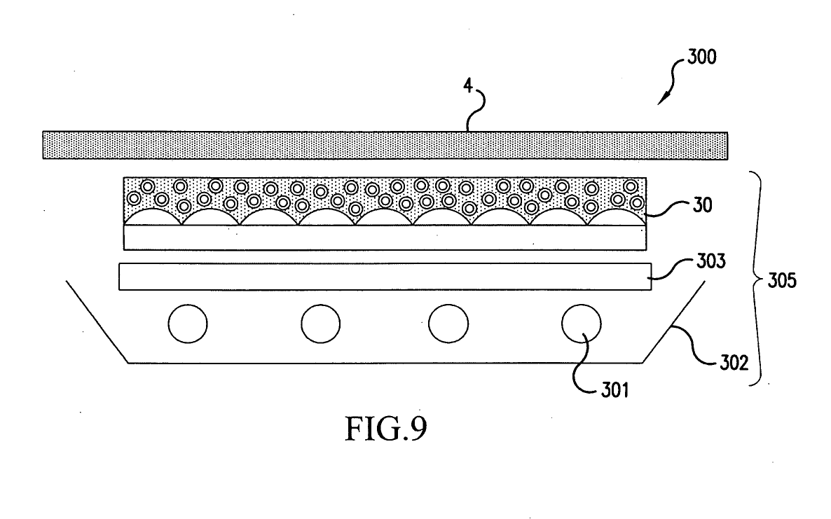

With reference to FIG. 9, a liquid crystal display device 300 includes a liquid crystal display panel 4 (liquid crystal display element), and a backlight unit 305 (illumination device). The backlight unit 305 includes a plurality of light sources 301, a reflection member 302 provided under the light sources 301 (on the opposite side to the liquid crystal display panel 4), a light diffusion plate 303 provided on the light sources 301 (on the side of the liquid crystal display panel 4), and an optical adjusting sheet 30 provided on the light diffusion plate 303. In FIG. 9, the optical adjusting sheet 30 is an example of the optical adjusting sheet, while the optical adjusting sheet 10, 20 or 40 may be applied instead of the optical adjusting sheet 30. Note that in FIG. 9, the optical members are illustrated as if they are apart from one another for the ease of illustrating the structure of the liquid crystal display device 300, but in practice they are stacked in contact with one another. In the direct type backlight unit and the liquid crystal display including the unit, incident light to the optical adjusting sheet 30 is provided with appropriate scattering (diffusion) and light collecting effects by the hollow beads dispersed within the light diffusion layer.

In the above-describe embodiment, the incident light is white light (visible light), while the invention is not limited to the arrangement, and when the incident light is monochromatic light, the same effect can be provided by adjusting the size and distribution of bubbles dispersed in the light diffusion layer as required depending on the wavelength.

### Fourth Embodiment

Optical Adjusting Sheet

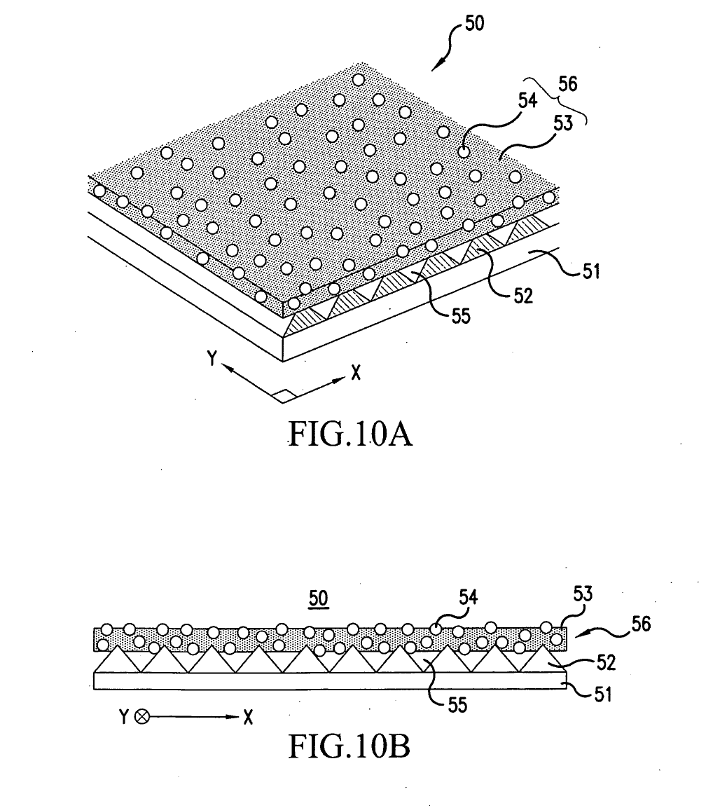

FIGS. 10A and 10B are schematic views of an optical adjusting sheet (optical adjusting member) according to a fourth embodiment of the invention. FIG. 10A is a perspective view and FIG. 10B is a side view seen from the Y-direction in FIG. 10A. The optical adjusting sheet 50 includes a sheet type base member 51, a plurality of prisms 52 (lenses) provided on the base member 51, and a light diffusion layer 56 formed on the plurality of prisms 52, and top edge parts of the prisms 42 are buried in the diffusion layer. The light diffusion layer 56 includes resin 53 and beads 54 (diffusion objects) dispersed within the resin 53.

The optical adjusting sheet 50 further has gaps 55 between the grooves of the lens group consisting of the plurality of prisms 52 and the light diffusion layer 56. More specifically, the prisms 52 have an interface with air (refractive index: 1.0). The top edge parts of the plurality of prisms 52 are buried in the light diffusion layer 56 and thus fixed.

The base member 51 has optical transparency. An example of the material of the base member 51 may include polyethylene terephthalate (PET), polyethylene naphthalate, polystyrene, polycarbonate (PC), polyolefin, polypropylene, cellulose acetate, or an inorganic transparent material such as glass. The base member 51 may have an arbitrary shape such as a sheet shape or a plate shape having a thickness about in the range from 1 mm to 100 mm. Note that when the sheet type base member 51 is used, the base member 51 preferably has a thickness in the range from 30 μm to 500 μm in consideration of working readiness and handling ability.

The prism 52 is a linear lens having the same structure as that of the prisms 505b in the conventional prism sheet in FIG. 20, extends in a predetermined direction (Y-direction in FIG. 10A) and has a triangular section orthogonal to the lengthwise direction. The prisms 52 are made of resin having optical transparency. The refractive index of the material of the prisms 52 is preferably in the range from 1.4 to 1.7.

The shape and size of the prisms 52 may be changed as required depending on the required optical characteristic, use, and workability. When for example the workability (handling ability or the like) in forming the light diffusion layer 56 on the plurality of prisms 52 is considered, the prisms 52 preferably have a height about in the range from 7 μm to 50 μm. The vertical angle of the prism 52 is preferably in the range from 60° to 120°. When the angle is set in the above-described range, the traveling direction of light from the light source may effectively be changed by the prisms 52 into the upper surface direction (thickness-wise direction) of the base member 51.

The plurality of prisms 52 are arranged in the direction orthogonal to the lengthwise direction (X-direction in FIG. 10A). In FIGS. 10A and 10B, adjacent prisms 52 are provided adjacent to each other, while they may be provided apart from each other. The pitch of the prisms 52 can be changed as required depending on the necessary optical characteristic, use, workability and the like. For example, in consideration of the workability (handling ability or the like) in forming the light diffusion layer 56 on the plurality of prisms 52, the pitch of the prisms 52 is preferably about in the range form 7 μm to 200 μm. The plurality of prisms 52 may be arranged at equal pitch or randomly. The plurality of prisms 52 may be arranged so that a plurality of cycles (pitches) are present. The plurality of prisms 52 may have different shapes or sizes from one another. More specifically, as long as the top edge parts of the prisms 52 are buried in the light diffusion layer 56, and the light diffusion layer 56 may stably be fixed, the shape or structure of the prisms 52 is not particularly limited.

The light diffusion layer 56 includes resin 53 and a plurality of bead-shaped diffusion objects (hereinafter simply as “beads”) 54. The resin 53 may be any arbitrary one of resin materials having high optical transparency and workability. Examples of such materials for the resin 53 may include kinds of transparent plastic resin such as ultraviolet curing type acrylic resin, urethane resin, styrene resin, polyester, fluororesin, and silicone resin. The average thickness of the light diffusion layer 56 is preferably in the range from 1 μm to 200 μm.

Various kinds of materials may be used for the beads 54. Examples of the materials may include oxide such as silica, and titania, alumina, and zirconia, acrylic resin, a transparent inorganic material such as nitride, and transparent plastic resin such as acrylic resin, urethane resin, styrene resin, polyester, and vinyl chloride. The particle diameter and shape of the beads 54 may be set as required depending on the necessary optical characteristic and the like. The average particle diameter of the beads 54 is preferably about in the range from 1 μm to 100 μm in consideration of the light diffusion characteristic and the beads 54 preferably has a spherical shape.

The bead 54 preferably has a refractive index different from that of the resin 53. As the difference between the refractive indexes of the beads 54 and the resin 53 is greater, the diffusion effect is more significant. When the resin 53 is ultraviolet curing resin, its refractive index is about 1.5, and therefore the refractive index of the beads 54 is in the range from 1.35 to 1.45 or from 1.55 to 2.2. Part of the plurality of beads 54 preferably protrudes from the surface of the light diffusion layer 56, so that a higher diffusion effect is obtained.

In consideration of the optical transparency and light diffusion characteristic, the mixing ratio of the beads 54 relative to 100 parts by weight of the resin 53 is in the range from 10 to 300 parts by weight, and the mixing ratio of the beads 54 to the resin layer and the combination of the materials of the resin 53 and beads 54 may be adjusted as required, so that the diffusion characteristic of incident light at the light diffusion layer 56 can be adjusted.

Light incident to the optical adjusting sheet 50 is refracted at an interface between the prism 52 and air. At the time, since the refractive index difference between the prism 52 and the air (refractive index: 1.0) is sufficiently large, a sufficient refraction effect results, so that the directivity of light can sufficiently be made parallel. Then, the refracted light is incident to the light diffusion layer 56 and subjected to the diffusion effect. More specifically, in the optical adjusting sheet 50, the directivity of the light can sufficiently be made parallel at the interface between the prism 52 and the air (gap 55), and the light having its directivity made parallel can be diffused at the light diffusion layer 55. Therefore, the use of the single optical adjusting sheet 50 provides a sufficient light collecting effect and the effect of improving the problems of the moiré, the homogeneity of output light, the chromatic dispersion of output light, and the like is also provided. More specifically, the function and effect obtained using the prism sheet and the diffusion sheet provided thereon in a conventional liquid crystal display device (such as in FIG. 21) can be obtained using the single optical adjusting sheet 50.

Method of Manufacturing Optical Adjusting Sheet

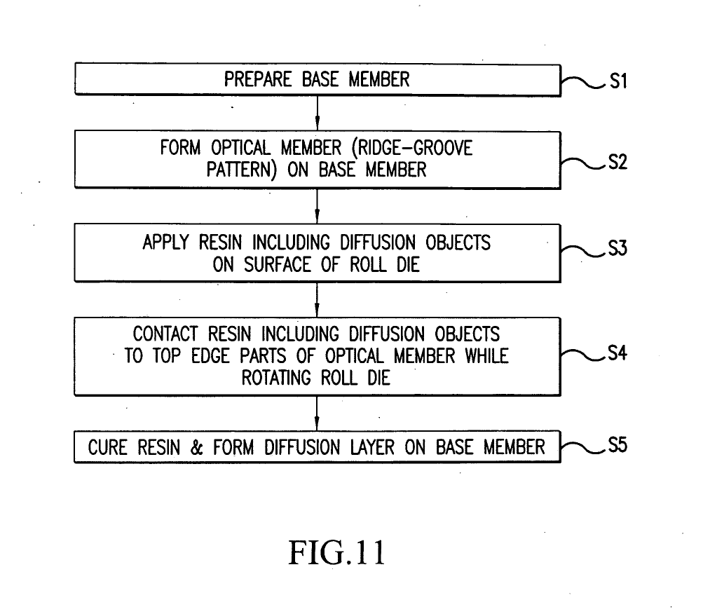

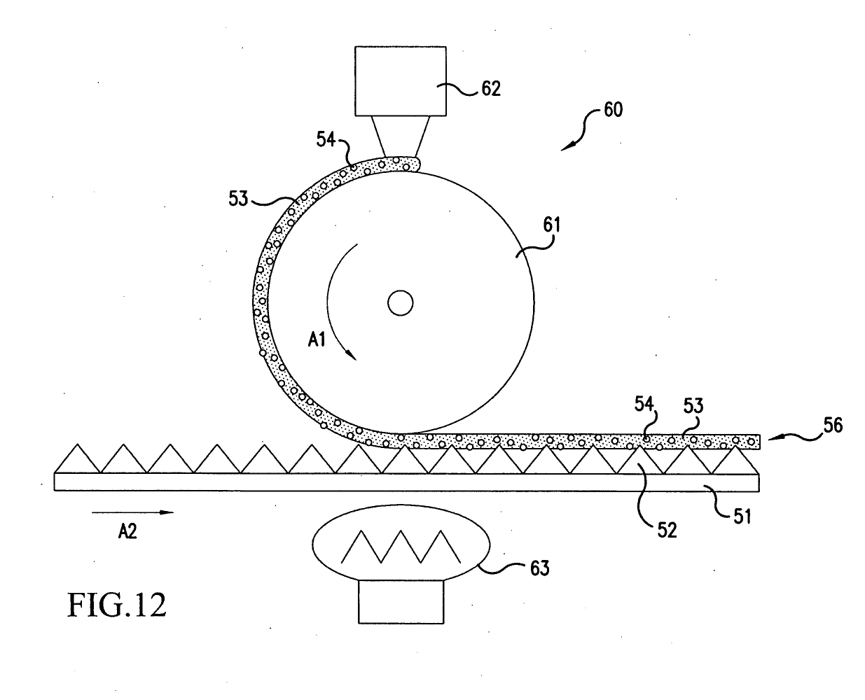

Now, a method of manufacturing the optical adjusting sheet 50 will be described with reference to FIGS. 11 and 12. FIG. 11 is a flowchart for use in illustrating the process of the manufacturing method, and FIG. 12 is a schematic view of how the light diffusion layer 56 is formed and a manufacturing device use for the process.

A base member 51 is prepared (step S1 in FIG. 11). Then, a plurality of prisms 52 are formed on the base member 51 (step S2 in FIG. 11). More specifically, the plurality of prisms 52 are formed on the base member 51 as follows. A die having the inverse of the ridge-groove shape of the plurality of prisms 52 formed on its surface is prepared. The ridge-groove surface of the die is for example formed by cutting. Then, the die is provided on the base member 51, and ultraviolet curing resin is filled between the base member 51 and the die and cured. Then, the die is removed from the base member 51.

The method of forming the plurality of prisms 52 on the base member 51 is not limited to the above and a method of manufacturing a conventional optical adjusting sheet (such as a prism sheet) may be applied. For example, a die having a predetermined ridge-groove shape on its surface is heated and pressed against the base member, so that the ridge-groove pattern of the die is directly transferred onto the surface of the base member. In other words, thermal transfer may be employed to deform the base member itself and optical members (prisms) may be formed on the surface of the base member. Alternatively, a well-known method such as extrusion molding and press-molding or injection molding, by which molten resin is injected to the die, may be employed.

Then, the light diffusion layer 56 is formed on the plurality of prisms 52 as follows. To start with, a manufacturing device used to form the light diffusion layer 56 will be described with reference to FIG. 12. The manufacturing device 60 includes a roll type die 61 (hereinafter also referred to as “roll die”), a resin supplier 62 that coats the surface of the roll die 61 with the material of the light diffusion layer 56 (the ultraviolet curing resin 53 including the beads 54), and a ultraviolet irradiation device 63 used to cure the resin 53 in contact with the top edge parts of the plurality of prisms 52. The ultraviolet irradiation device 63 is positioned opposed to the roll die 61 with the base member 51 interposed therebetween so that ultraviolet light is mainly directed at a region where the top edge parts of the prisms 52 and the resin 53 applied on the surface of the roll die 61 begin to contact. The resin supplier 62 is positioned immediately above the roll die 61. Note that the roll die 61 has a mirror surface.

The base member 51 having the plurality of prisms 52 formed on its surface is mounted to the manufacturing device 60 and the base member 51 is fed to the side of the roll die 61 (in the direction of the arrow A2 in FIG. 3). At the time, as shown in FIG. 12, the base member 51 is mounted so that the plurality of prisms 52 are opposed to the roll die 61.

Then, the ultraviolet curing resin 53 including the beads 54 is applied on the surface of the roll die 61 rotated in the direction of the arrow A1 in FIG. 12 using the resin supplier 62 (step S3 in FIG. 11). At the time, the thickness of the applied ultraviolet curing resin 53 is preferably sufficiently smaller (thinner) than the height of the prisms 52. Note that the beads 54 are dispersed within the ultraviolet curing resin 53 using a known dissolver or the like. Then, as shown in FIG. 12, in the region between the roll die 61 and the base member 51, the ultraviolet curing resin 53 applied on the surface of the roll die 61 is contacted with the top edge parts of the prisms 52 (step S4 in FIG. 11). In this way, the top edge parts of the prisms 52 are buried in the ultraviolet curing resin 53.

Then, the region between the roll die 61 and the base member 51 is subjected to ultraviolet irradiation from the ultraviolet irradiation device 63, so that the ultraviolet curing resin 53 in which the top edge parts of the prisms 52 are buried is cured and the light diffusion layer 56 is formed (step S5 in FIG. 11). At the time, as shown in FIG. 12, the top edge parts of the prisms 52 are buried in the resin 53 of the light diffusion layer 56, the light diffusion layer 56 and the top edge parts of the prisms 52 are adhesively fixed and/or fixed by melting with each other. According to the embodiment, the ultraviolet curing resin 53 is cured almost simultaneously as it is contacted to the top edge parts of the prisms 52. Stated differently, the ultraviolet curing resin 53 applied on the surface of the roll die 61 is sequentially cured from the part contacted to the plurality of lenses as the roll die 61 rotates.

As a method of forming the light diffusion layer on the base member, the base member having the prisms formed thereon and the light diffusion layer may be prepared (manufactured) separately and adhered later. However, according to the method, there must be the step of producing the light diffusion layer and the step of adhering the prisms on the base member and the light diffusion layer, i.e., at least two steps are necessary. On the other hand, according to the method as described above, the step of contacting the resin to the prisms and the step of curing the resin may be carried out at the same time. If these steps are carried out simultaneously, the step of producing the light diffusion layer and the step of adhering the prisms and the light diffusion layer can be carried out in one step. Therefore, as compared to the method according to which the base member having the prisms formed thereon and the light diffusion layer are separately prepared, the optical adjusting sheet can be manufactured more readily and in a shorter period.

If the ultraviolet curing resin 53 is contacted with the top edge parts of the prisms 52, and the ultraviolet curing resin 53 is cured almost at the same time, the ultraviolet curing resin 53 is not filled in the region between adjacent prisms 52.

By the method, gaps 55 form between the plurality of prisms 52 and the light diffusion layer 56.

According to the manufacturing method described above, the step of contacting the ultraviolet curing resin 53 to the top edge parts of the prisms 52 and the step of curing the ultraviolet curing resin 53 are carried out almost at the same time, while if the material of the light diffusion layer 56 has sufficient viscosity while it is still uncured and a cross-linked state (in which the gaps 55 are formed between the prisms 52 and the light diffusion layer 56) can be maintained, the step of contacting the ultraviolet curing resin 53 to the top edge parts of the prisms 52 and the step of curing the ultraviolet curing resin 53 may not have to be carried out at the same time.

Then, the light diffusion layer 56 is passed through the region between the roll die 61 and the base member 51, and the light diffusion layer 56 is removed from the roll die 61. In this way, the optical adjusting sheet 50 is produced.

Liquid Crystal Display Device and Illumination Device

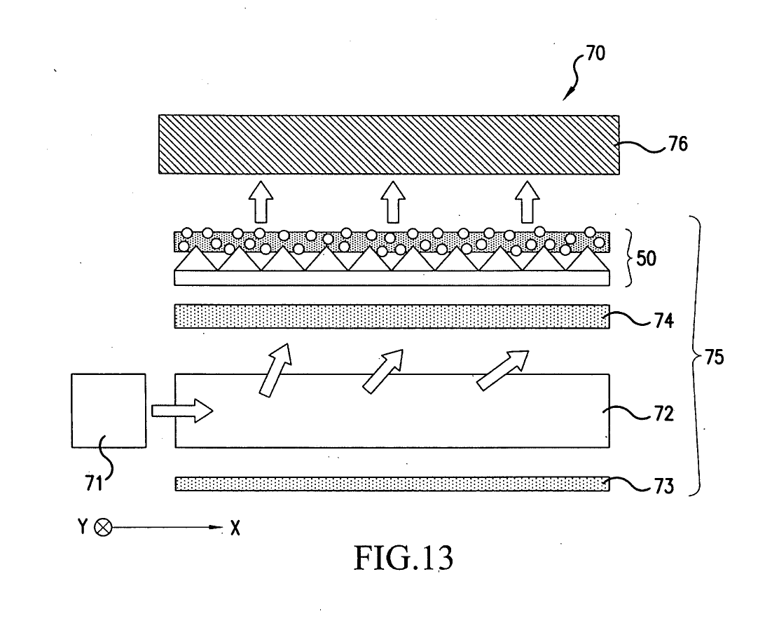

FIG. 13 is a schematic view of a liquid crystal display device including the optical adjusting sheet 50. In FIG. 13, the optical members are illustrated as if they are apart from one another for the ease of illustrating the structure of the liquid crystal display device, but in practice they are stacked in contact with one another. The liquid crystal display device 70 includes a liquid crystal display panel 76 (liquid crystal display element) and a backlight unit 75 (illumination device).

The liquid crystal display panel 76 is the same as the liquid crystal display panel in the conventional liquid crystal display device. More specifically, though not shown, the liquid crystal display panel 76 for example includes a polarizer plate, a glass substrate, a transparent conductive film that forms a pixel electrode, an alignment film, a liquid crystal layer, an alignment film, a transparent conductive film that forms a counter electrode, a color filter, a glass substrate, and a polarizer plate stacked on one another in the mentioned order.

The backlight unit 75 includes a light source (LED: light emitting diode) 71, a light guide plate 72 that changes light radiated from the light source 71 into a surface light source, a reflection sheet 73 provided under the light guide plate 72 (on the opposite side to the liquid crystal display panel 76), a diffusion sheet 74 provided on the light guide plate 72 (on the side of the liquid crystal display panel 76), and the optical adjusting sheet 50 provided on the diffusion sheet 74. The backlight unit 75 is an edge light type illumination device and the light source 71 is provided at a side of the light guide plate 72.

The optical members other than the optical adjusting sheet 50 are the same as those of the conventional backlight unit.

As described above, the use of the single optical adjusting sheet 50 provides a light collecting effect and a diffusion effect. Stated differently, the use of the single optical adjusting sheet 50 can provide the same function and effect as those provided by the prism sheet 505 and the diffusion sheet 506 in the conventional liquid crystal display device 500 shown in FIG. 21. Therefore, in the liquid crystal display device 70 and the backlight unit 75, the number of optical sheets can be reduced (by the thickness of the one base member of the optical sheet to be specific) as compared to the conventional liquid crystal display device 500, so that the thickness of the device can be reduced and the cost can be reduced.

### Inventive Example 4

An example of the optical adjusting sheet 50 was produced by the above-described method. Hereinafter, the optical adjusting sheet thus produced will be referred to as “optical adjusting sheet in Inventive Example 4.” The base member of the optical adjusting sheet in Inventive Example 4 was a polyethylene terephthalate (PET) sheet having a refractive index of 1.57 and a thickness of 50 μm. The prisms are made of ultraviolet curing resin having a refractive index of 1.59, each had a cross section in the shape of an isosceles triangle having a vertical angle of 90°, a base as long as 60 μm, and a height of 30 μm. The distance (pitch) between adjacent prisms was 60 μm.

The light diffusion layer included ultraviolet curing type acrylic resin with a refractive index of 1.53 and a plurality of glass beads whose average particle diameter was 3 μm. The content of the glass beads was 60 parts by weight relative to 100 parts by weight of the acrylic resin. The average thickness of the light diffusion layer was 10 μm.

The optical adjusting sheet in Inventive Example 4 thus produced was mounted to the backlight unit shown in FIG. 13. Hereinafter, the backlight unit thus produced will be referred to as “backlight unit in Inventive Example 4.” A light guide plate used in the backlight unit in Inventive Example 4 was made of polycarbonate. A reflection sheet 73 was a PET film having silver vapor-deposited on its surface. A lower diffusion sheet 74 was a PET film coated with beads. The thickness of the lower diffusion sheet 74 was 70 μm and the haze was 85%.

The front side luminance ratio and view angle of the backlight unit in Inventive Example 4 were measured. Here, in the luminance characteristic, the range of angle at which at least half the maximum luminance was provided was defined as the view angle.

For comparison, the front side luminance ratio and view angle in a conventional edge-light type backlight unit 508 (a comparative example) as shown in FIG. 21 were measured. In the backlight unit 508 in the comparative example, the optical members other than the prism sheet 505 and the upper diffusion sheet 506 were the same as those of the backlight unit in Inventive Example 4. Note that the shape of a section of the prism orthogonal to the lengthwise direction of the prism formed at the prism sheet 505 in the comparative example was an isosceles triangle whose width at the base was 60 μm, height was 30 μm and vertical angle was 90°. The upper diffusion sheet 506 was a PET film coated with beads having a thickness of 70 μm and a haze of 30%.

As a result of evaluation, in the backlight unit in Inventive Example 4, the front side luminance ratio was about 1.15 times, and the view angle was about 48° (42° in the comparative example). Therefore, the luminance characteristic was better than that in the comparative example for both values. This was probably because in the backlight unit in Inventive Example 4, the thickness equivalent to the one base member of the optical sheet can be reduced, and the loss of light was reduced accordingly. In the backlight unit in Inventive Example 4, no moiré was generated at the display screen.

As can be understood from the above-described result, in the backlight unit and the liquid crystal display device including the optical adjusting sheet 50, the optical characteristic (brightness, view angle, display quality and the like) was improved over the conventional devices. In addition, in the backlight unit and the liquid crystal display device including the optical adjusting sheet 50, the thickness equivalent to the one base member can be reduced, not only the optical characteristic can be improved but also a backlight unit and a liquid crystal display device having a smaller thickness can be obtained less costly than the conventional devices. Since the optical adjusting sheet 50 has the light diffusion layer formed at the top edge parts of the prisms and therefore the prisms (lens surfaces) are less susceptible to damages, and the prisms can be prevented from being damaged or worn by contacting or being pressed against the liquid crystal panel, or friction in the liquid crystal display device including the prisms.

### Fifth Embodiment

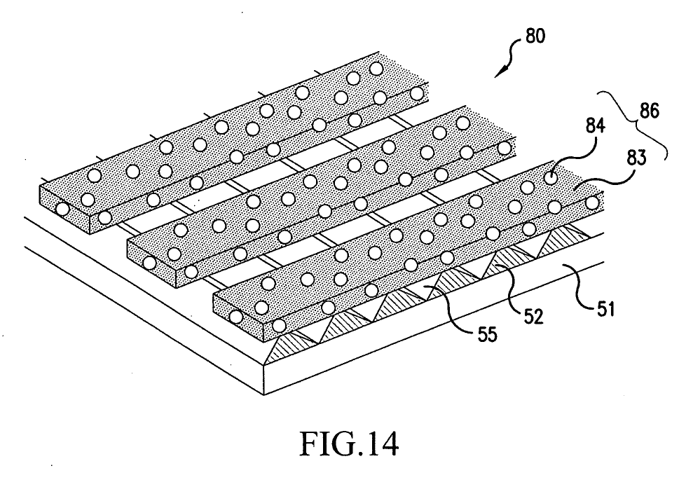

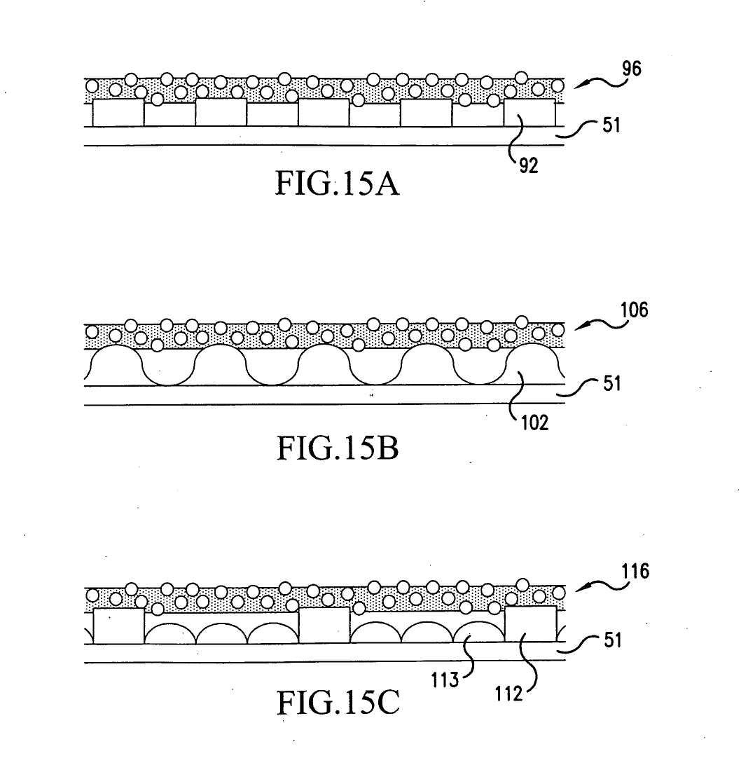

FIG. 14 is a schematic view of an optical adjusting sheet according to a fifth embodiment of the invention. The optical adjusting sheet 80 includes a sheet type base member 51, a plurality of prisms 52 provided on the base member 51, and a plurality of light diffusion layers 86 formed on the plurality of prisms 52.

In the optical adjusting sheet 50, the light diffusion layer 56 formed on the plurality of prisms 52 is made of a single sheet member, while the optical adjusting sheet 80 has the plurality of light diffusion layers 86 provided in parallel and apart from one another. The other structure of the optical adjusting sheet 80 is the same as that of the optical adjusting sheet 50.

The size and shape of each of the light diffusion layers 86, the size of the gap between adjacent light diffusion layers 86, and the manner of how to arrange the plurality of light diffusion layers 86 can be changed depending on the use, required optical characteristic and the like. In one example, the light diffusion layers 86 have a thickness of 15 μm and a width of 70 μm on average, and the gap between adjacent light diffusion layers 86 was 30 μm.

The optical adjusting sheet 80 is produced using the device shown in FIG. 12 similarly to the optical adjusting sheet 50. However, a roll die having a plurality of grooves that correspond to the plurality of light diffusion layers 86 is used as a roll die 21. The ridge-groove pattern on the surface of the roll die 21 may be formed by blasting or cutting. The pattern may also be formed by a method such as gravure printing. The shape and size of the plurality of the light diffusion layers 86 may be set as required depending on the required optical characteristic and the like. The light diffusion layer 86 may have a rectangular cross section, a triangular (prism shaped) cross section, or arch-shaped (lens shaped) cross section such as a semi-circle and a semi-ellipse.

The grooved part of the surface of the roll die 21 is coated with ultraviolet curing resin 83 including beads 84. At the time, the ultraviolet curing resin 83 is applied at a predetermined groove part and then the resin 83 sticking to the part other than the groove part is preferably scraped away using a spatula shaped member.

Then, while the roll die 21 is rotated, the ultraviolet curing resin 83 including beads 84 and the top edge parts of the prisms 52 are contacted. In this case, the prisms are preferably made of an elastic material, so that they can readily be contacted to the ultraviolet curing resin including the beads, which is preferable. Almost simultaneously with this step, the ultraviolet curing resin 83 in contact with the top edge parts of the prisms 52 is irradiated with ultraviolet light from the ultraviolet irradiation device 63 and cured. In this example, the plurality of light diffusion layers 86 are formed on the plurality of prisms 52 in this way. Other than the step of forming the light diffusion layers 86, the optical adjusting sheet 80 is produced similarly to the fourth embodiment.

Note that in the optical adjusting sheet 80, the plurality of light diffusion layers 86 are formed apart from one another on the plurality of prisms 52, while one light diffusion layer having a predetermined ridge-groove pattern formed on its surface may be formed on the plurality of prisms 52 instead of the plurality of light diffusion layer 86. As shown in FIG. 14, a plurality of light diffusion layers may be formed on the lenses, or a surface of the light diffusion layer may be provided with a ridge-groove pattern, so that not only a light diffusion effect but also a light controlling effect such as collecting light by refraction may be additionally provided to the light diffusion layers. This is particularly effective when the plurality of light diffusion layers extend orthogonally to the lengthwise direction of the prisms.

In the fourth and fifth embodiments described above, the optical adjusting sheets have a light diffusion layer formed on a plurality of prisms having a triangular section orthogonal to the lengthwise direction, while the invention is not limited to the arrangement. The shape of the lenses may be changed as required depending on the use, necessary optical characteristic and the like, and the lens may be a cylindrical lens having an arch-shaped (such as semi-circular and semi-elliptical) section and extending in a predetermined direction. Alternatively, the lens may be an optical member other than a prism or a cylindrical lens.

For example, as shown in FIG. 15A, a plurality of optical members 92 having a rectangular section orthogonal to the lengthwise direction may be formed on a base member 91, and a light diffusion layer 96 in which the top edge parts of the plurality of optical members 92 are buried may be formed on the plurality of optical members 92. The light diffusion layer 96 has the same structure as that of the light diffusion layers 56 and 86.

As shown in FIG. 15B, a light diffusion layer 106 may be formed on a plurality of optical members 102 having a corrugated section orthogonal to the lengthwise direction.

As shown in FIG. 15C, a light diffusion layer 116 may include a plurality of optical members 112 having a rectangular section orthogonal to the lengthwise direction and a plurality of optical members 113 having a semi-circular (lens-shaped) section and a lower height than the optical members 112 provided parallel on a base member 11 and the top edge parts of the optical members 112 may be buried in the light diffusion layer 116. In this case, the optical members 113 and the light diffusion layer 116 are not in contact with each other, the light collecting function of the top edge parts can be improved as compared to the case in which they are in contact.

In the example shown in FIG. 15C, three optical members 113 having a semi-circular section are provided between the optical members 112 having a rectangular section, while the shape and size of the optical members 112 and 113 and the manner of how to arrange them may be changed as required depending on the necessary optical characteristic and the like.

The optical adjusting sheets shown in FIGS. 15A to 15C can be produced by the same manufacturing method as the optical adjusting sheet 50, and gaps can be formed between the plurality of lenses formed on the base member and the light diffusion layer. Therefore, the optical adjusting sheets have the same effect as that of the optical adjusting sheet 50.

The lenses formed on the base member may have for example a trapezoidal section orthogonal to the lengthwise direction (not shown). In this case, the adhering surface between the plurality of lenses and the light diffusion layer may be wider than that of the optical adjusting sheet 50, so that the light diffusion layer may be fixed more stably on the plurality of lenses.

In the examples in FIGS. 15A to 15C, the lens shapes are different from the above-described embodiments, while a light diffusion layer different from the light diffusion layers according to the above-described embodiments may be used.

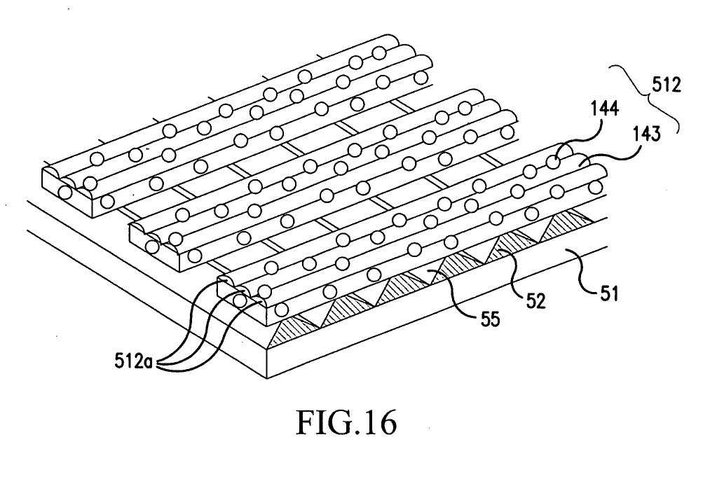

As shown in FIG. 16, a plurality of diffusion layers 512 may each have a plurality of cylindrical lenses 512a formed on the surface. The cylindrical lens 512a has a semi-circular cross section and the lengthwise direction of the cylindrical lenses 512a crosses the lengthwise direction of the prism members 52. The lower surface of the light diffusion layers 512 are flat, and the top edge parts of the plurality of prisms 52 are buried in the lower surface side of the light diffusion layers 512. Note that resin 143 and beads 144 that form the light diffusion layers 512 are the same as those of the optical adjusting sheet 80.

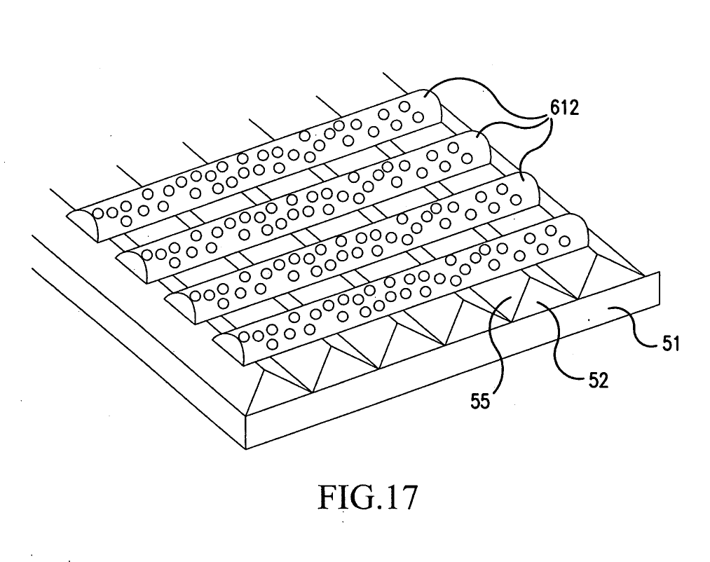

As shown in FIG. 17, each of the plurality of light diffusion layers 612 may form a cylindrical lens.

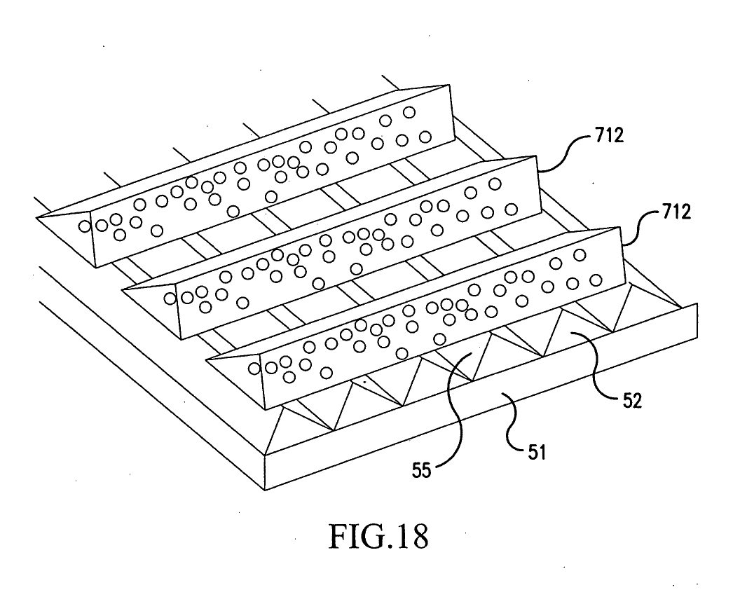

As shown in FIG. 18, a plurality of prism-shaped light diffusion layers 712 may extend apart from one another on the prisms 52 in the direction orthogonal to the lengthwise direction of the prisms 52.

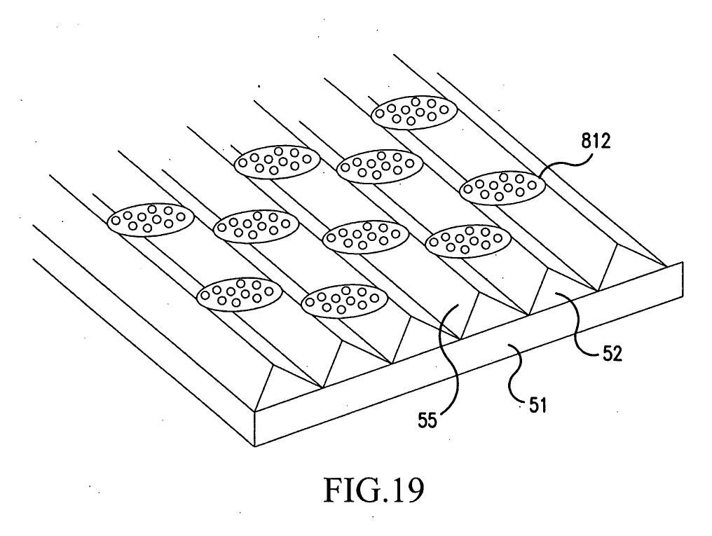

As shown in FIG. 19, each of light diffusion layers 812 has a plano-convex lens shape having a flat bottom surface and the diameter of the bottom surface may be greater than the distance between the top edges of adjacent prisms 52. The shape may be a plano-concave lens shape instead of the plano-convex lens shape.

In the fourth and fifth embodiments described above, the beads (that are not hollow inside) are used as the diffusion objects, while the invention is not limited to the above. For example, silica beads or acrylic beads that are hollow inside may be used. The shape is not limited to a sphere, and any arbitrary shape based on a design such as polygonal and random shapes that provide diffusion performance may be employed. When the hollow beads are used as the diffusion objects, the refraction index difference is large at an interface between the outer shell of each of the hollow beads and the inside (air), therefore a refraction effect can be obtained at the interface between the outer shell and inside (air) of the hollow bead, and the effective refractive index of the light diffusion member may be lowered. In addition, optical members and light diffusion members having various structures may be combined to form the optical adjusting members according to the invention.

The optical adjusting sheets in the embodiments described above may be applied to a side light type or direct type backlight unit.

Although the embodiments of the present invention have been described, they are by way of illustration and example only and should not be construed as limitative. The invention may be embodied in various modified forms without departing from the spirit and scope of the invention.

### INDUSTRIAL APPLICABILITY

The optical adjusting member according to the invention has the light collecting function, diffusion function, and protection function at the same time, and therefore the optical adjusting member is an optical member preferably applied to optical adjusting members for various kinds of use, an illumination device and a liquid crystal display device.

What is claimed is:

1. An optical adjusting member, comprising:
a base member having optical transparency;
a plurality of lenses formed on said base member; and
a light diffusion layer formed on said plurality of lenses, at least top edge parts of said lenses being buried in the light diffusion layer.

2. The optical adjusting member according to claim 1, wherein
said light diffusion layer has a plurality of bubbles dispersed therein.

3. The optical adjusting member according to claim 2, wherein said plurality of bubbles include:
a plurality of first bubbles having a size less than the wavelength of incident light; and
a plurality of second bubbles having a size at least as large as the wavelength of incident light.

4. The optical adjusting member according to claim 3, wherein said light diffusion layer is made of resin having optical transparency.

5. The optical adjusting member according to claim 4, wherein said bubble has a refractive index smaller than that of said resin.

6. The optical adjusting member according to claim 2, wherein said light diffusion layer comprises:
a plurality of hollow particles including said bubbles inside and having optical transparency; and
resin having said plurality of hollow particles dispersed therein and having optical transparency.

7. The optical adjusting member according to claim 2, wherein said plurality of lenses each extend in a predetermined direction and are arranged parallel to one another.

8. The optical adjusting member according to claim 7, wherein said lens has a triangular cross section.

9. The optical adjusting member according to claim 7, wherein said lens has an arch-shaped cross section.

10. The optical adjusting member according to claim 1, having a gap between said lenses and said light diffusion layer.

11. The optical adjusting member according to claim 10, wherein said plurality of lenses include:
a plurality of first lenses; and
a plurality of second lenses having a greater height than that of said first lenses,
at least top edge parts of said second lenses being buried in said light diffusion layer.

12. An illumination device, comprising:
a light source; and
an optical adjusting member to which light from said light source is incident,
said optical adjusting member comprising:
a base member having optical transparency;
a plurality of lenses formed on said base member; and
a light diffusion layer formed on said plurality of lenses, at least top edge parts of said lenses being buried in said light diffusion layer.

13. The illumination device according to claim 12, further comprising a light guide plate used to guide light from said light source to said optical adjusting member.

14. A liquid crystal display device, comprising:
a light source;
an optical adjusting member to which light from said light source is incident; and
a liquid crystal display element laid on said optical adjusting member,
said optical adjusting member comprising:
a base member having optical transparency;
a plurality of lenses formed on said base member; and
a light diffusion layer formed on said plurality of lenses, at least top edge parts of said lenses being buried in the light diffusion layer.

15. A method of manufacturing an optical adjusting member including a base member having a plurality of lenses formed on its surface and a light diffusion layer formed on said plurality of lenses, at least top edge parts of said lenses being buried in said light diffusion layer, said method comprising the steps of:
preparing said base member;
applying resin used to form said light diffusion layer on a surface of a roll;
contacting the resin applied on said roll surface to the top edge parts of said plurality of lenses while rotating said roll on said plurality of lenses; and
curing the resin in contact with the top edge parts of said plurality of lenses, thereby forming said light diffusion layer.

16. The method of manufacturing an optical adjusting member according to claim 15, wherein in said step of forming said light diffusion layer, the resin applied on said roll surface is sequentially cured from the part contacted to said plurality of lenses by the rotation of said roll.

17. The method of manufacturing an optical adjusting member according to claim 15, wherein said optical adjusting member comprises a plurality of said light diffusion layers,
said roll has a plurality of grooves on a surface, and
in said step of applying said resin, said resin is filled in said plurality of grooves.
